(19) United States
(12) Patent Application Publication
(10) Pub. No.: US 2016/0275450 A1
(43) Pub. Date: Sep. 22, 2016

(54) Method of Providing Access to a Secure Receptacle to Complete a Package Delivery

(71) Applicant: James Chan-Chia Chang, Eastvale, CA (US)

(72) Inventor: James Chan-Chia Chang, Eastvale, CA (US)

(21) Appl. No.: 15/076,333

(22) Filed: Mar. 21, 2016

Related U.S. Application Data
(60) Provisional application No. 62/135,874, filed on Mar. 20, 2015.

(51) Int. Cl. G06Q 10/08; E05B 65/00; E05G 1/04; G06F 21/31

(52) U.S. Cl. CPC G06Q 10/0836; G06F 21/31; E05B 65/0075; E05G 1/04

(57) ABSTRACT

A method of providing access to a secure receptacle to complete a package delivery is implemented through a storage compartment, a central server, a recipient computing device, and a courier computing device. The overall process includes a generation of a one-time key code by the central server upon completion of a purchase order, wherein the recipient computing device completes and transmits the purchase order. The one-time key code is then provided to the storage compartment and the courier computing device. The one-time key code allows a courier that assigned to the courier computing device to unlock the storage compartment and place a purchased product in the storage compartment. This ensures the secure placement of the purchased product. Additionally, when the storage compartment is unlocked through the one-time key code, the recipient computing device is notified that the package delivery process completed.

The current application claims a priority to the U.S. Provisional Patent application Ser. No. 62/135,874 filed on Mar. 20, 1015.

### FIELD OF THE INVENTION

The present invention relates generally to package delivery methods. More specifically, the present invention is a secure receptacle and a method of providing access to a courier to complete a package delivery process.

### BACKGROUND OF THE INVENTION

Home deliveries are an extremely common occurrence, aided by the convenience of making purchases from online vendors. Consumers can buy numerous items from the comfort of their homes or work places, without having to make a trip to a traditional brick and mortar store. However, a drawback of having items delivered is the lack of security. For example, packages sitting unattended outside a person's residence can easily be stolen. Furthermore, such packages are often exposed to the elements, resulting in possible degradation or damage of a package's contents due to inclement weather or extreme temperature conditions. Due to the aforementioned reasons, there is a need to improve package deliveries by providing a secure receptacle which has restricted access.

It is therefore an object of the present invention to utilize a temporary password in conjunction with the secure receptacle. The temporary password is generated when an order is placed and ultimately provided to a courier. The temporary password thus allows the courier to unlock the secure receptacle in order to complete a delivery process. Once used, the temporary password expires for security purposes. Additionally, a package recipient is also notified about the delivery confirmation when the temporary password is used by the courier. As a result, the present invention provides an improved security and a delivery notification process by means of the secure receptacle.

### BRIEF DESCRIPTION OF THE DRAWINGS

FIG. 1 is a graphical diagram showing the overall process and components of the present invention.

FIG. 2 is a basic flow chart illustrating the overall process of the present invention.

FIG. 3 is a basic flow chart illustrating the components configuration within the overall process of the present invention.

FIG. 4 is a basic flow chart illustrating the temperature regulating system within the overall process of the present invention.

FIG. 5 is a basic flow chart illustrating the preferred method of one-time key code implementation within the overall process of the present invention.

FIG. 6 is a basic flow chart illustrating the alternative method of one-time key code implementation within the overall process of the present invention.

### DETAIL DESCRIPTIONS OF THE INVENTION

All illustrations of the drawings are for the purpose of describing selected versions of the present invention and are not intended to limit the scope of the present invention.

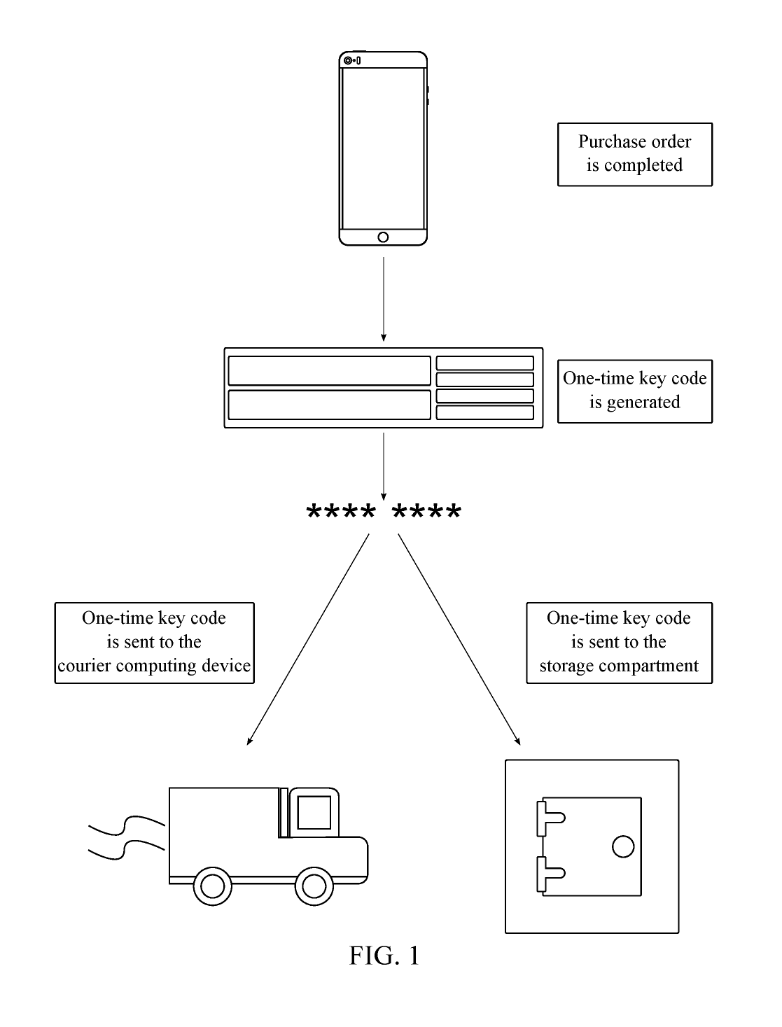

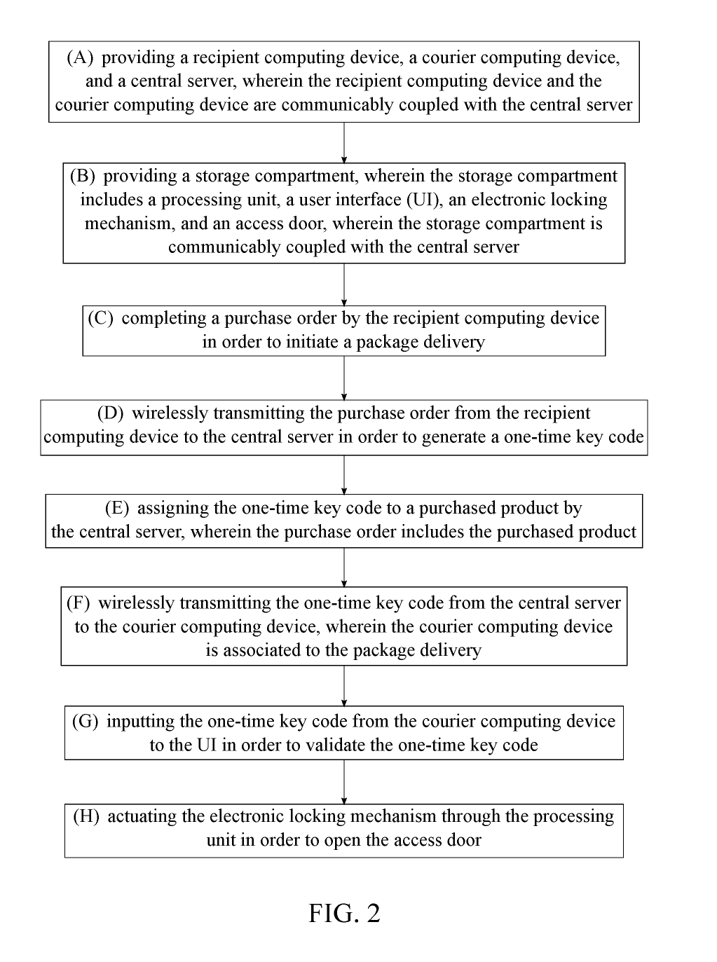

The present invention generally relates to package delivery method and systems. More specifically, the present invention provides a more secure means of receiving packages compared to simply leaving a package on a doorstep or otherwise unattended and open location. The steps of the present invention are implemented through a storage compartment that is located at an address where a package is being delivered, a central server, a recipient computing device, and a courier computing device. Due to the component configuration and the functionality of the present invention, the storage compartment is recognized as the secure means of receiving packages. The storage compartment, the recipient computing device, and the courier computing device are communicably coupled with the central server so that the present invention can efficiently improve the package delivery process. In reference to FIG. 1-2, the overall process of the present invention is implemented by the generation of a one-time key code that is then provided to the storage compartment and the courier computing device. The one-time key code allows a courier that is assigned to the courier computing device to unlock the storage compartment and place a purchased product in the storage compartment. This ensures the secure placement of the purchased product while minimizing security risks via the use of the one-time key code, as compared to a static key code. Furthermore, when the storage compartment is unlocked through the one-time key code, the recipient computing device is notified of the package delivery process.

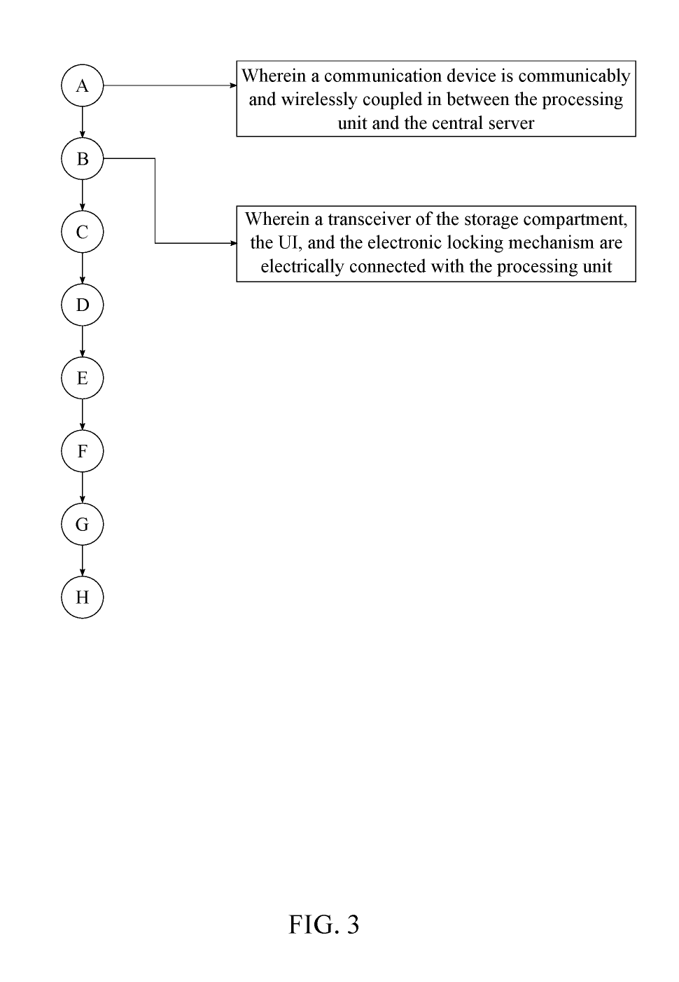

The storage compartment is an enclosure with an access point, allowing packages and other items to be placed into or removed. In reference to FIG. 2-3, the storage compartment comprises a transceiver, a user interface (UI), an electronic locking mechanism, an access door, a temperature regulating system, and a processing unit. The electronic locking mechanism located within a main body of the storage compartment and engages with the access door. The electronic locking mechanism prevents unauthorized access to the storage compartment and its contents as the access door is only actuated through the electronic locking mechanism. The UI allows the courier to enter the one-use key code in order to unlock the storage compartment. The UI can include, but is not limited to, a simple keypad, a capacitive touch screen, and a microphone with voice recognition capabilities. The transceiver allows the storage compartment to be wirelessly notified of the one-time key code, such that the one-time key code allows the courier to access the storage compartment. The transceiver also allows the storage compartment to wirelessly notify the recipient computing device when the one-time key code has been used by the courier. In order to perform and complete input/output operations between the transceiver, the UI, and the electronic locking mechanism, the processing unit is electrically connected with the transceiver, the UI, and the electronic locking mechanism. As a result, the transceiver, the UI, and the electronic locking mechanism are able to communicate with each other with a plurality of specific operation instructions that is stored within the processing unit. The processing unit also utilizes a communication device and a local wireless area network to be communicably and wirelessly coupled with the central server. More specifically, the communication device enhances the capabilities and coverage area of the local wireless area network as the communication device is communicably and wirelessly coupled in between the processing unit and the central server. As a result, the storage compartment can be positioned adjacent to an outside mailbox or any other accessible locations, where the distance between the local wireless area network and the processing unit becomes irrelevant.

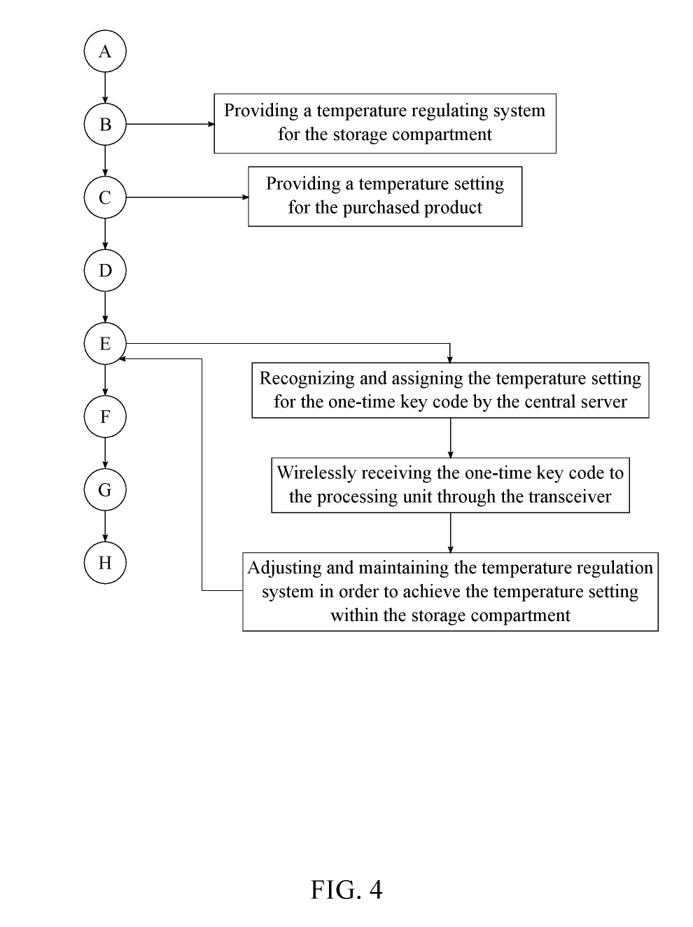

In reference to FIG. 4, the temperature regulating system can be an optional accessory within the storage compartment. The temperature regulating system is simply meant to expand the functionalities of the present invention. Exclusion of the temperature regulating system does not detract the overall functionality of the present invention in any way. The temperature regulating system monitors and maintains the internal temperature of the present invention to a desired level. The temperature regulating system is electrically connected with the processing unit so that the temperature regulating system can be controlled through the processing unit. For example, if a delivered package contains food items which are prone to spoilage, such as produce, meats, and dairy products, the temperature regulating system can maintain the internal temperature at a level that is determined safe by FDA (Food and Drug Administration) regulations, commonly 40 degrees Fahrenheit or lower. The temperature regulating system can also be used to heat the container if necessary. For example, when the present invention receives pharmaceutical products in cold weather regions and the pharmaceutical products often have a “safe” temperature range of storage, the temperature regulating system may require to heat the storage compartment, especially during winter.

The storage compartment is preferably anchored to the ground, exceptionally heavy, or otherwise be effectively immobile. This is to prevent the storage compartment itself from being taken, which would allow potential thieves the luxury of time when attempting to access the contents of the container. Potentially, the storage compartment can be provided with at least one separate compartment and the integrated temperature regulating system, allowing the storage compartment to hold different items at different temperatures. The storage compartment can be unlocked by a permanent key-code or even a physical key, provided solely for a recipient who is assigned to the recipient computing device, to provide convenience access to the recipient of the storage compartment.

The recipient computing device and the courier computing device encompass a variety of possible commercially available products. A common example for both the recipient computing device and the courier computing device is a smart phone. Smart phones are excellent options to use within the present invention. Smart phones are ubiquitous in modern society, have high market penetration, and are easily carried on one's person or otherwise transported. Another example of the recipient computing device and the courier computing device is a personal computer, whether in a desktop or a laptop form. For example, a person can place his or her order through a home computer. Likewise, the courier computing device could be an onboard computer which is integrated into the vehicle or simple a portable laptop that is kept with the courier. Ultimately, the recipient computing device and the courier computing device only need processing capability, the ability to run software (commonly referred to “applications” or “apps” for smart phones), and the ability to wirelessly transmit and receive data. The data transmission is often completed through a wireless network, such as mobile networks or local wireless area networks, where the type of the wireless network is determined upon the compatibility of the recipient computing device or the courier computing device.

The components thus far described implement the overall process of the present invention. Variations and substitutions to the aforementioned components are possible while remaining within the scope of the present invention. The components of the present invention are provided to allow the courier to deliver the purchased product to the storage compartment at an address, from which the recipient can later retrieve the purchased product. Security risks are minimized by the electronic locking mechanism and the one-time key code that is generated for each purchase order and only valid for the corresponding purchase order.

In reference to FIG. 2, the package delivery process of the present invention is initiated through the recipient computing device as a purchase order is completed by the recipient computing device. The purchase order comprises relevant information regarding the purchased product and is completed by the recipient. For example, the purchase order comprises relevant information such as a recipient name, a shipping address, a billing address, at least one purchased product, and special instructions or notes regarding the purchased product. Once the purchase order is completed through the recipient computing device, the purchase order is wirelessly transmitted from the recipient computing device to the central server in order to generate the one-time key code. The one-time key code is generated by the central server after the purchase order for the purchased product is completed and transmitted. Often the purchase order is placed via the internet and the central server is able to automatically generate the one-time key code. However, when the purchase order is placed by a phone or postal mail, the purchase order is completed by a separate computing device that is communicably coupled with the central server.

After the one-time key code is generated, the central server assigns the one-time key code to the purchased product, wherein the purchase order includes the purchased product. The one-time key code is also wirelessly transmitted from the central server to the courier computing device that is associated with the package delivery. The one-time key code acts as a temporary password for the courier who is delivering the purchased product to unlock the storage compartment. Optionally, the one-time key code can also be generated through the recipient computing device upon completion of the purchase order. If the one-time key code is generated by the recipient computing device, then the one-time key code is wirelessly transmitted to the central server, which proceeds to route the one-time key code to the appropriate courier computing device.

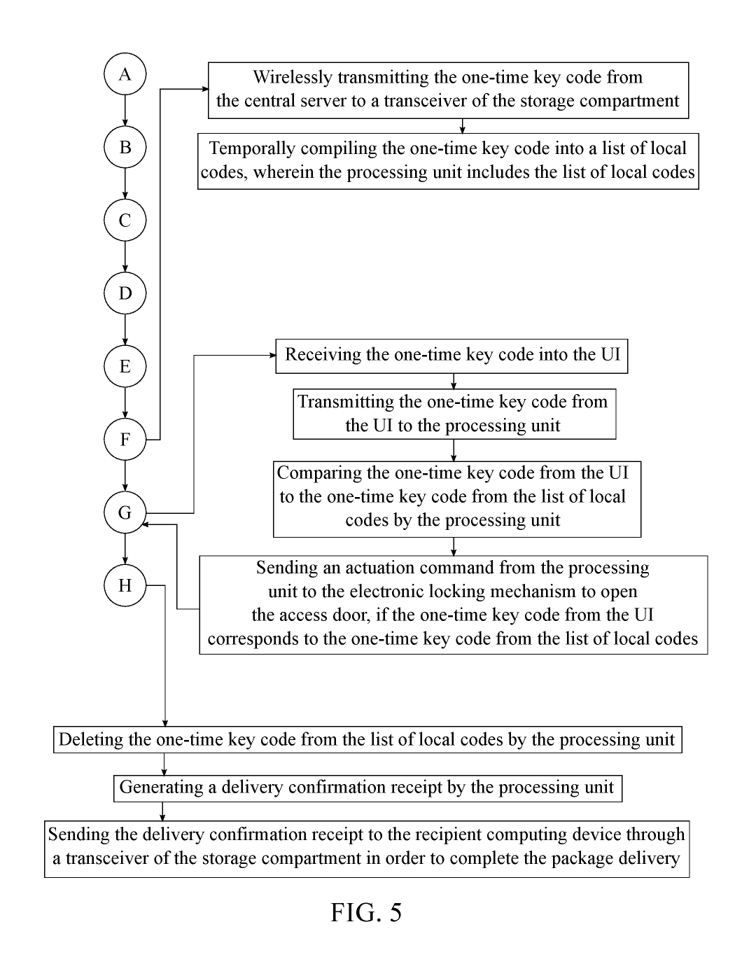

In reference to the preferred method of the present invention that is shown in FIG. 5, once the one-time key code is generated, the one-time key code is also wirelessly transmitted to the storage compartment from the central server. More specifically, the storage compartment receives the one-time key code through the transceiver and routs the one-time key code to the processing unit. The one-time key code is then temporally compiled into a list of local codes that is assigned within the processing unit. After the one-time key code is stored within the list of local codes, the storage compartment is ready to accept the purchased product from the courier. When the courier inputs the one-time key code to the UI, the processing unit can validate the one-time key code with the list of local codes and actuate the electronic locking mechanism to open the access door. More specifically, once the UI receives the one-time key code, the UI transmits the one-time key code to the processing unit. The processing unit then compares the one-time key code from the UI to the one-time key code from the list of local codes. If the processing unit is able to find the one-time key code from the list of local codes that corresponds with the one-time key code from the UI, the processing unit sends an actuation command to the electronic locking mechanism to open the access door. As a result, the courier can physically insert the purchased product into the storage compartment and close the access door to complete the package delivery process.

Additionally, the processing unit deletes the one-time key code from the list of local codes, ensuring that the one-time key code does not provide future access to the storage compartment. In addition to deleting the one-time key code from the list of local codes, the processing unit also generates and sends a delivery confirmation receipt to the recipient computing device through the transceiver. Thus the delivery confirmation receipt is provided with instantaneous delivery notification. Then the present invention is able to complete the package delivery process.

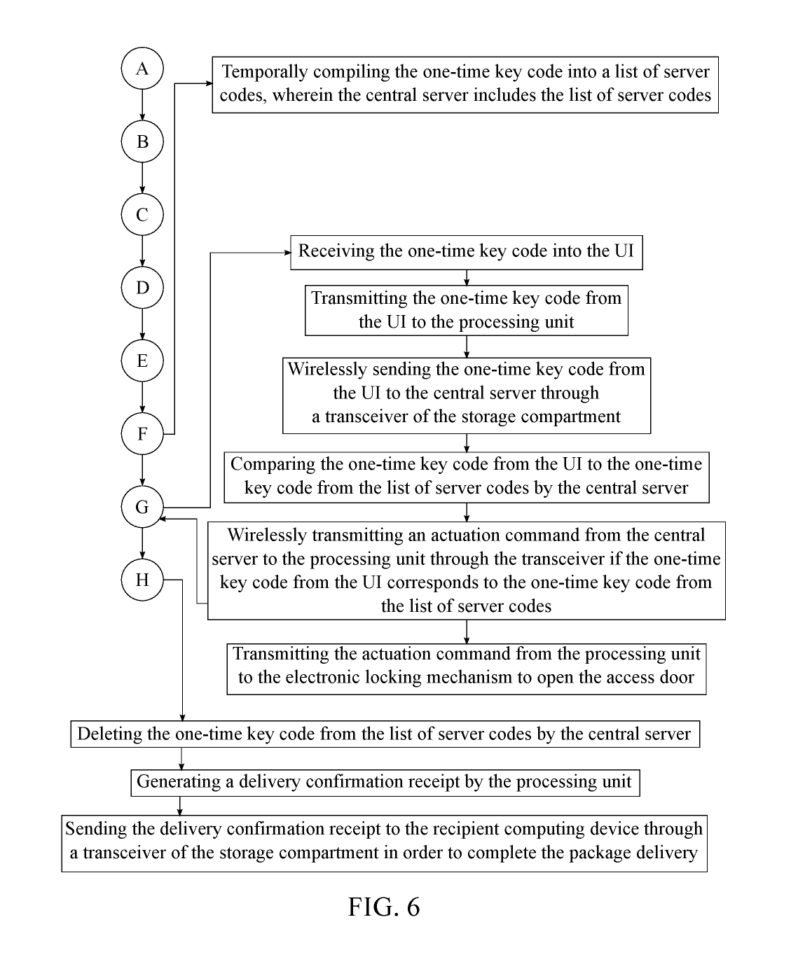

In reference to the alternative method of the present invention that is shown in FIG. 6, once the one-time key code is generated, the one-time key code is temporally compiled into a list of server codes that is assigned within the central server. After the one-time key code is stored within the list of server codes, the storage compartment becomes ready to accept the purchased product form the courier. When the courier inputs the one-time key code to the UI, the processing unit can validate the one-time key code with the list of server codes and actuate the electronic locking mechanism to open the access door. More specifically, once the UI receives the one-time key code, the UI transmits the one-time key code to the processing unit. Then the processing unit wirelessly transmits the one-time key code from the UI to the central server through the transceiver. The central server then compares the one-time key code from the UI to the one-time key code from the list of server codes. If the central server is able to find the one-time key code from the list of server codes that corresponds with the one-time key code from the UI, the central server wirelessly transmits an actuation command to the processing unit. The processing unit is then able to transmit the actuation command to the electronic locking mechanism to open the access door. As a result, the courier can physically insert the purchased product into the storage compartment and close the access door to complete the package delivery process.

Additionally, the central server deletes the one-time key code from the list of server codes, ensuring that the one-use key code does not provide future access to the storage compartment. Simultaneously, the processing unit generates and sends a delivery confirmation receipt to the recipient computing device through the transceiver. Thus the delivery confirmation receipt is provided with instantaneous delivery notification. Then the present invention is able to complete the package delivery process.

The one-time key code can potentially be used to provide relevant instructions for the temperature regulating system. For example, if the purchase order is for temperature sensitive goods such as meats, the generated one-time key code can relay a temperature setting to the temperature regulating system in addition to unlocking the storage compartment. The temperature setting is associated with the purchased product and recognized by the central server during the process of generating the one-time key code. More specifically, when the central server recognizes the temperature setting associated with the purchased product, the temperature setting is assigned to the one-time key code by the central server. Then the one-time key code is wirelessly transmitted to the processing unit through the transceiver. As a result, the processing unit is able to adjust and maintain the temperature regulating system in order to achieve the temperature setting within the storage compartment. Verification of the one-time key code and associated temperature regulating system for the temperature setting are illustrated via FIG. 4.

The order of some of the above steps can be flexible or additional steps can be added to the present invention to improve the efficiency. For example, to increase security of the package delivery process, the one-time key code may not be generated until the courier notifies the central server that the package is out for delivery. By waiting to generate the one-time key code until this point, the security of the purchase product is improved by reducing the number of generated one-time key codes at any given time. Other variations in steps may also be implemented as deemed desirable by vendors of the present invention.

Although the invention has been explained in relation to its preferred embodiment, it is to be understood that many other possible modifications and variations can be made without departing from the spirit and scope of the invention as hereinafter claimed.

What is claimed is:

1. A method of providing access to a secure receptacle to complete a package delivery comprises the steps of:
(A) providing a recipient computing device, a courier computing device, and a central server, wherein the recipient computing device and the courier computing device are communicably coupled with the central server;
(B) providing a storage compartment, wherein the storage compartment includes a processing unit, a user interface (UI), an electronic locking mechanism, and an access door, wherein the storage compartment is communicably coupled with the central server;
(C) completing a purchase order by the recipient computing device in order to initiate a package delivery;
(D) wirelessly transmitting the purchase order from the recipient computing device to the central server in order to generate a one-time key code;
(E) assigning the one-time key code to a purchased product by the central server, wherein the purchase order includes the purchased product;
(F) wirelessly transmitting the one-time key code from the central server to the courier computing device, wherein the courier computing device is associated to the package delivery;
(G) inputting the one-time key code from the courier computing device to the UI in order to validate the one-time key code; and
(H) actuating the electronic locking mechanism through the processing unit in order to open the access door.

2. The method of providing access to a secure receptacle to complete a package delivery as claimed in claim 1, wherein a transceiver of the storage compartment, the UI, and the electronic locking mechanism are electrically connected with the processing unit.

3. The method of providing access to a secure receptacle to complete a package delivery as claimed in claim 1, wherein a communication device is communicably and wirelessly coupled in between the processing unit and the central server.

4. The method of providing access to a secure receptacle to complete a package delivery as claimed in claim 1 comprises the steps of:
providing a temperature setting for the purchased product;
providing a temperature regulating system for the storage compartment, wherein the temperature regulation system is electrically connected with the processing unit;
recognizing and assigning the temperature setting for the one-time key code by the central server during step (E);
wirelessly receiving the one-time key code to the processing unit through the transceiver; and
adjusting and maintaining the temperature regulation system in order to achieve the temperature setting within the storage compartment.

5. The method of providing access to a secure receptacle to complete a package delivery as claimed in claim 1 comprises the steps of:
wirelessly transmitting the one-time key code from the central server to a transceiver of the storage compartment during step (F);
temporally compiling the one-time key code into a list of local codes, wherein the processing unit includes the list of local codes during step (F);
receiving the one-time key code into the UI during step (G);
transmitting the one-time key code from the UI to the processing unit;
comparing the one-time key code from the UI to the one-time key code from the list of local codes by the processing unit; and
sending an actuation command from the processing unit to the electronic locking mechanism to open the access door, if the one-time key code from the UI corresponds to the one-time key code from the list of local codes.

6. The method of providing access to a secure receptacle to complete a package delivery as claimed in claim 5 comprises the steps of:
deleting the one-time key code from the list of local codes during step (H) by the processing unit;
generating a delivery confirmation receipt by the processing unit; and
sending the delivery confirmation receipt to the recipient computing device through a transceiver of the storage compartment in order to complete the package delivery.

7. The method of providing access to a secure receptacle to complete a package delivery as claimed in claim 1 comprises the steps of:
temporally compiling the one-time key code into a list of server codes, wherein the central server includes the list of server codes during step (F);
receiving the one-time key code into the UI during step (G);
transmitting the one-time key code from the UI to the processing unit;
wirelessly sending the one-time key code from the UI to the central server through a transceiver of the storage compartment;
comparing the one-time key code from the UI to the one-time key code from the list of server codes by the central server;
wirelessly transmitting an actuation command from the central server to the processing unit through the transceiver,
if the one-time key code from the UI corresponds to the one-time key code from the list of server codes; and
transmitting the actuation command from the processing unit to the electronic locking mechanism to open the access door.

8. The method of providing access to a secure receptacle to complete a package delivery as claimed in claim 7 comprises the steps of:
deleting the one-time key code from the list of server codes during step (H) by the central server;
generating a delivery confirmation receipt by the processing unit; and
sending the delivery confirmation receipt to the recipient computing device through the transceiver in order to complete the package delivery.
